(19) United States
(12) Patent Application Publication
(10) Pub. No.: US 2016/0378935 A1
(43) Pub. Date: Dec. 29, 2016

(54) IMAGING BASED RESPONSE CLASSIFICATION OF A TISSUE OF INTEREST TO A THERAPY TREATMENT

(71) Applicant: KONINKLIJKE PHILIPS N.V., Eindhoven (NL)

(72) Inventor: Raz CARMI, HAIFA (IL)

(21) Appl. No.: 14/903,290

(22) PCT Filed: Jun. 26, 2014
(86) PCT No.: PCT/IB2014/062611

§ 371 Date: Jan. 7, 2016

Related U.S. Application Data
(60) Provisional application No. 61/846,242, filed on Jul. 15, 2013.

(51) Int. Cl. G06F 19/00

(52) U.S. Cl. CPC G06F 19/345; G06F 19/3443

(57) ABSTRACT

A method for determining a final response class of tissue of interest to a therapy treatment includes obtaining a first set of probabilities of response classes and at least a second set of probabilities of the response classes. The method further includes combining the first and the at least second sets of probabilities of the response classes, thereby generating a combined set of probabilities of the response classes. The method further includes determining the final response class of the tissue of interest to the therapy treatment from a plurality of predefined response classes based on the combined set of probabilities of the response classes. The method further includes generating a signal indicative of the final response class.

The following generally relates to imaging and more particularly to imaging based response classification of a tissue of interest for a therapy treatment such as a tumor therapy treatment, Alzheimer disease therapy treatment, and/or other therapy treatment.

Monitoring a response of a tissue of interest of a subject to a therapy treatment can facilitate effective treatment of the tissue of interest. For example, distinguishing, for one or more subjects, a tissue of interest that responds to a particular treatment from a tissue of interest not responding to the particular treatment can facilitate maximizing an effectiveness of treatment of the tissue of interest. For instance, for a subject with a tissue of interest that is responding to a particular treatment, the treatment can continue, and that is not responding to the particular treatment, the treatment can be changed or discontinued.

An imaging based assessment of the therapy treatment can provide an indication of the effectiveness of the treatment and has been used in therapy management. Anatomical imaging modalities such as computed tomography (CT) and magnetic resonance imaging (MRI) allow for an accurate assessment of changes in tumor size over the course of a therapy. The World Health Organization (WHO) criteria and the Response Evaluation Criteria in Solid Tumors (RECIST) have provided methodologies for assessing treatment response.

These methodologies have led to the adoption of anatomical imaging modalities in determining the efficacy of treatment for solid tumors in drug development and for regulatory approval, where reproducible quantitative results are of particular importance. Morphological criteria for complete response (CR), partial response (PR), stable disease (SD) and progressive disease (PD) have been established for the RECIST guidelines. Similar analysis schemes are frequently applied in tumor-tracking procedures of individual subjects.

With the increasing adoption of metabolic imaging with positron emission tomography (PET) or PET/CT, particularly with Fluorodeoxyglucose (¹⁸F) or fludeoxyglucose (¹⁸F) (also referred to as ¹⁸F-FDG or FDG) imaging in initial staging and follow-up of a variety of cancers, improvements for the RECIST criteria have been suggested in order to base them not only on tumor size, as measured by morphological imaging modalities like CT, but also on tumor metabolism parameters, like standardized uptake value (SUV), as measured by PET.

For PET, therapy response assessment criteria includes PET Response Criteria In Solid Tumors (PERCIST) and the International Harmonization Project for Response Criteria in Lymphoma, which have been proposed based on PET metabolic criteria. Since many newer cancer therapies may have different effect on tumor morphology during treatment, good tumor response may be associated predominantly with a decrease in metabolism or in other functional parameters such as blood perfusion, even in the absence of a major reduction in tumor size.

RECIST guidelines in practice evaluate response by assessing a set of measurable target lesions, and, an optional additional group of non-target or new lesions. This is performed in baseline and in follow-up imaging studies and the relations or changes between the follow-up results of different times are evaluated. Unfortunately, applying RECIST consistently is challenging, e.g., due to inter-observer variability among physicians such as oncologists and radiologists, and due to the inherent uncertainties in the selection and measurement of target lesions, which has been achieved manually or using automated software.

Particularly, a tumor lesion may have very irregular and complicated shape and/or metabolic distribution, which may introduce inherent uncertainty in extracting lesion characteristics and parameters. Improvements in automatic lesion segmentation and analysis algorithms and corresponding software have been developed and include improved reporting, tracking and comparison schemes. Other sources of such uncertainties and inaccuracies include the choice of tracked lesion selection by a user, the imaging modality and protocol, contrast agent injection, image quality, noise, patient position, the evaluation tools, etc.

Imaging indications of therapy response in non-cancerous diseases include, for example, the amount and distribution in the brain of beta amyloid plaque associated with dementia and Alzheimer disease, which can be imaged with PET and MRI.

However, even the state of the art tracking clinical application tools do not thoroughly evaluate the uncertainties and inaccuracies of the overall diagnosis. This includes current computerized methods which enable more automatic and reliable tumor-tracking workflow. Unfortunately, the uncertainties and inaccuracies can lead to erroneous diagnosis and therapy course selection.

Aspects described herein address the above-referenced problems and others.

The following describes an approach for assessing a response of a tissue of interest to a therapy treatment. In one instance, the assessment is based on parameter measurement uncertainties and/or sets of probabilities of response classes. The assessment includes combining the sets of probabilities of response classes, and determining an overall response class for the therapy treatment based on the combination.

In one aspect, a method for determining a final response class of tissue of interest to a therapy treatment includes obtaining a first set of probabilities of response classes and at least a second set of probabilities of the response classes. The method further includes combining the first and the at least second sets of probabilities of the response classes, thereby generating a combined set of probabilities of the response classes. The method further includes determining the final response class of the tissue of interest to the therapy treatment from a plurality of predefined response classes based on the combined set of probabilities of the response classes. The method further includes generating a signal indicative of the final response class.

In another aspect, a therapy response classifier includes a combined response classes probability determiner that combines a first set and at least a second set of probabilities of response classes for tissue of interest to a therapy treatment, generating a combined set of probabilities of the response classes and a response class determiner that determines a final response class of the tissue of interest to the therapy treatment from the response classes based on the combined set of probabilities of the response classes.

In another aspect, a computer readable storage medium is encoded with computer readable instructions, which, when executed by a processer, causes the processor to: obtain at least two sets of probabilities of response classes, wherein the response classes include at least two classes indicative of two different response of tissue of interest to a therapy treatment, combine the at least two sets of probabilities, and determine a final response class of the tissue of interest to the therapy treatment based on the combined at least two sets of probabilities.

The invention may take form in various components and arrangements of components, and in various steps and arrangements of steps. The drawings are only for purposes of illustrating the preferred embodiments and are not to be construed as limiting the invention.

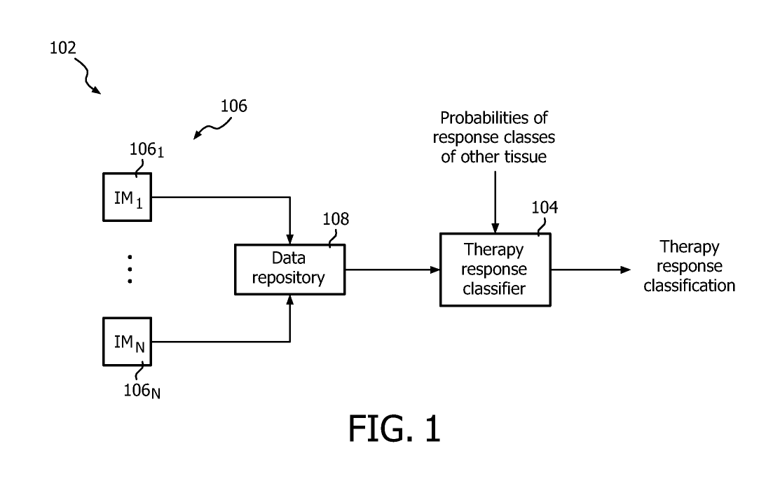

FIG. 1 schematically illustrates an example system 102 including at least a therapy response classifier 104 and an imaging system(s) 106.

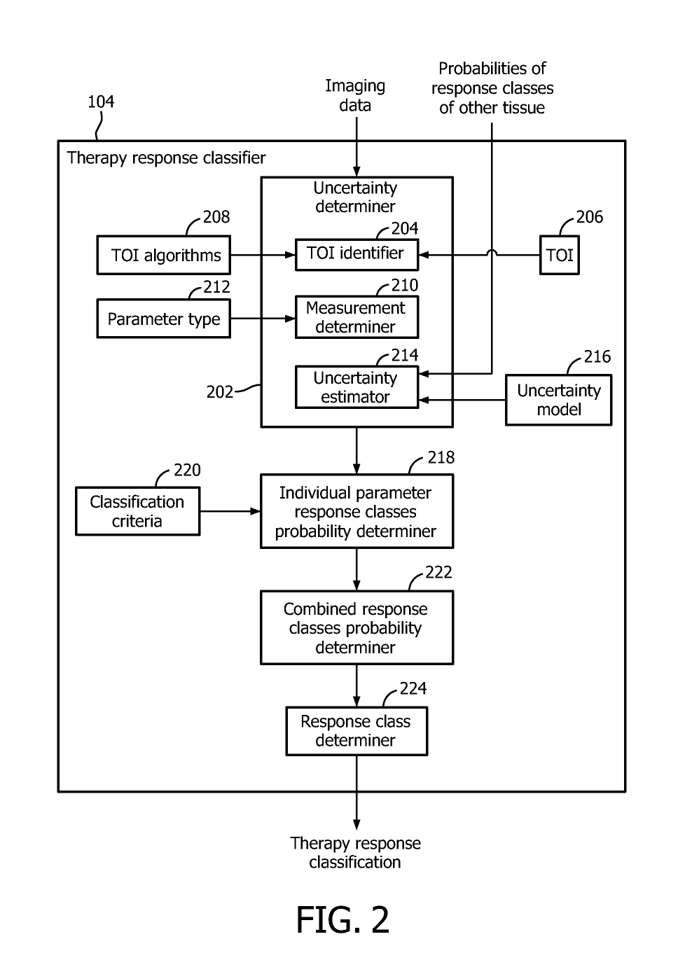

FIG. 2 schematically illustrates an example of the therapy response classifier of FIG. 1.

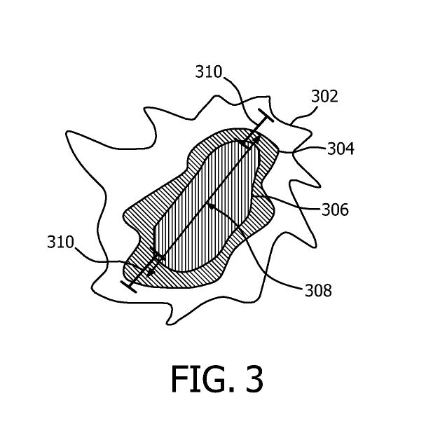

FIG. 3 illustrates examples of different measurements for a single parameter of tissue of interest at one point in time and a corresponding uncertainty.

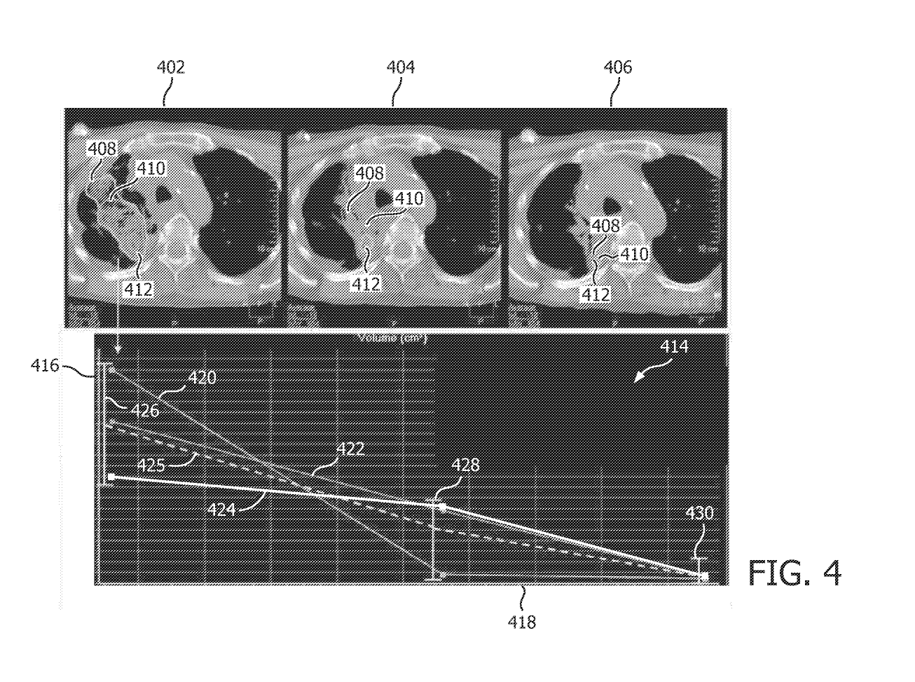

FIG. 4 illustrates an example of visualizing the different measurements for tissue of interest over multiple points in time and uncertainties at each point in time.

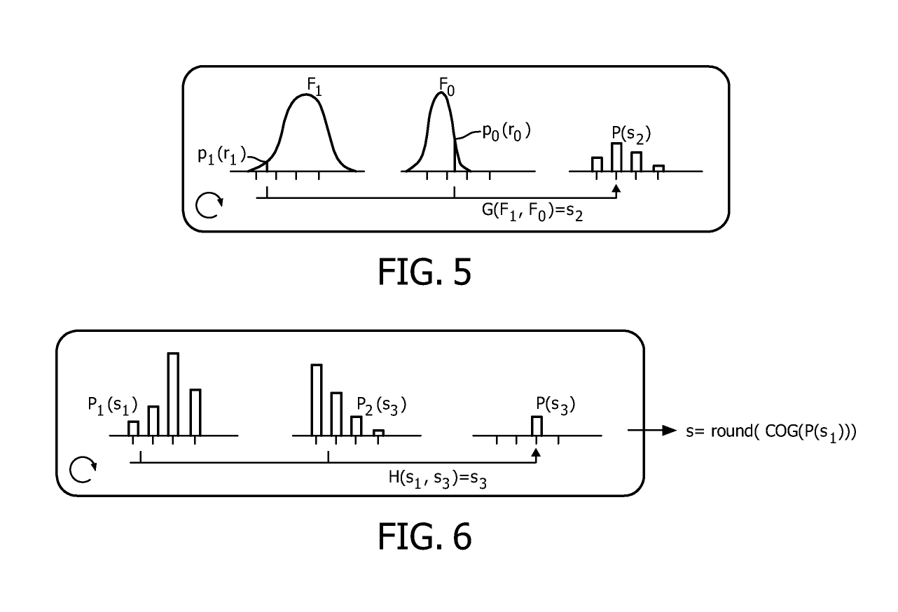

FIG. 5 illustrates an approach for determining a set of probabilities of response classes for a parameter measurement.

FIG. 6 illustrates an approach for combining sets of probabilities of response classes.

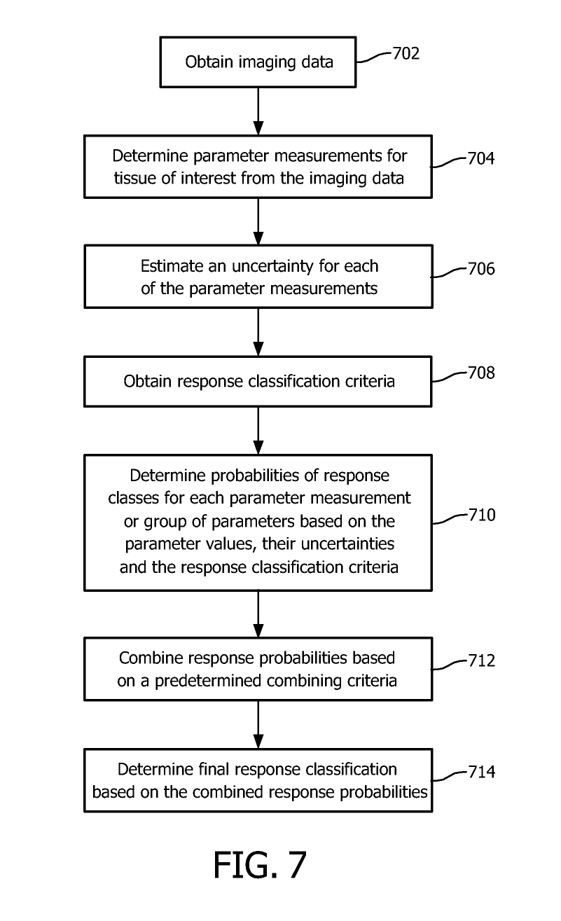

FIG. 7 illustrates an example method in accordance with the embodiments herein.

The following describes an approach for determining, based on imaging data, a response class of a tissue of interest to a therapy treatment.

FIG. 1 illustrates a system 102 including a therapy response classifier 104 in connection with N imaging systems 106 (where N is a positive number equal to or greater than one), including an imaging system 106₁, . . . , 106_{N} and a data repository 108, which can be a separate storage component (as shown), part of the imaging systems 106. The N imaging systems 106 includes one or more of a computed tomography (CT) scanner, a magnetic resonance imaging (MRI) scanner, a positron emission tomography (PET) scanner, a hybrid or multi-modality (e.g., a PET/CT) scanner, and/or other imaging system(s).

One or more different imaging techniques can be performed on the same scanner and/or different scanner. For example, anatomical CT and functional dynamic contrast-enhanced CT can be performed with the same CT scanner. The N imaging systems can also include different imaging instances of the same technique.

The data repository 108 can be used to store imaging data generated by the N imaging systems 106. The data repository 108 can include storage local to one or more of the N imaging systems 106 and/or storage remote from the one or more of the N imaging systems 106. The data repository 108 can include a radiology information system (RIS), a hospital information system (HIS), a picture archiving and communication system (PACS), an electronic medical record (EMR), a server, a database, and/or other data storage device.

The imaging data stored in the data repository 108 at least includes imaging data acquired at two different points in time during a therapy treatment (e.g., radiation therapy, chemotherapy, disease-targeted medication, etc.). For instance, the imaging data may include data acquired pre and post a therapy treatment, after each fraction of a therapy treatment, at two different points in time after a therapy treatment, etc. Such data can be from a same or different imaging system of the imaging systems 106.

The therapy response classifier 104 classifies a response of the tissue of interest to the therapy treatment. As described in greater detail below, this includes obtaining an uncertainty for each of a plurality of parameter measurements, evaluating the parameters and their uncertainties based on predetermined classification criteria, determining probabilities for each different possible class, combining the probabilities for different imaging systems, groups of tissue of interest, different response point, etc. based on predetermined combining criteria, and determining a final classification of the response based on the combined probabilities.

Optionally, the final classification is also based on probabilities of response classes for other tissue (i.e., tissue other than the tissue of interest) and/or already determined probabilities of response classes for the tissue of interest. Examples of suitable classifications include, but are not limited to the Response Evaluation Criteria in Solid Tumors (RECIST) and the PET Response Criteria In Solid Tumors (PERCIST). RECIST response classes include, for example, complete response (CR), partial response (PR), stable disease (SD) and progressive disease (PD). Other response classes are also contemplated herein. For example, other classifications include absent or present, new tissue of interest, etc.

Using the uncertainties and the probabilities as described herein may reduce response class inaccuracies relative to a configuration in which the therapy response classifier 104 does not consider the uncertainties and the probabilities. As such, the described approach is well suited for monitoring a response of a tumor, Alzheimer disease, etc. to therapy to determine an effectiveness of the therapy and to validate and/or adjust the treatment. For example, where the therapy response classification of the therapy response classifier 104 indicates that the tissue of interest is responding as desired to a therapy treatment, the therapy treatment can be continued. However, where the therapy response classification of the therapy response classifier 104 indicates that the tissue of interest is not responding as desired to the therapy treatment, the therapy treatment can be changed to a different therapy treatment or discontinued.

It is to be appreciated that the therapy response classifier 104 can be implemented via one or more computer processors (e.g., a central processing unit (CPU), a microprocessor, etc.) executing one or more computer executable instructions embedded or encoded on computer readable storage medium such as physical memory and excluding non-transitory medium. At least one of the computer executable instructions can alternatively be carried by a carrier wave, signal, and other transitory medium.

FIG. 2 illustrates an example of the therapy response classifier 104. As discussed herein and shown in FIG. 2, the therapy response classifier 104, in one instance, receives, as an input, imaging data (e.g., from the data repository 108, one or more of the imaging system 106, and/or other device) and, optional probabilities of response of classes of other tissue (or tissue other than the tissue of interest).

An uncertainty determiner 202 determines an uncertainty for each of the parameter measurements based on the input imaging data.

The uncertainty determiner 202 includes a tissue of interest (TOI) identifier 204 that identifies one or more tissues of interest in the imaging data based on a tissue of interest (TOI) 206 and tissue of interest (TOI) algorithms 208. The TOI 206 can be, for example, one or more tumors being treated with the therapy treatment, where each tumor is identified using two or more of the TOI algorithms 208. The TOI identifier 204 can identify the tissue(s) of interest based on an automated segmentation algorithm and/or in connection with user interaction, e.g., based on input indicative of a user identified contour in the imaging data.

The uncertainty determiner 202 further includes a parameter measurement determiner 210 that determines one or more parameter measurements of the identified tissue of interest based on one or more predetermined parameter types 212. This includes multiple measurements for the same parameter, where each measurement is based on different identified tissue of interest for the same TOI 206, which is identified using a different algorithm of the TOI algorithms 208. Examples of parameter types include anatomical size (e.g. volume, longest length, shortest length), mean, maximum and/or other intensity value (e.g. SUV in PET, HU in CT, contrast-agent enhancement), etc.

The uncertainty determiner 202 further includes an uncertainty estimator 214 that estimates an uncertainty for each of the parameters based on the measurements of each of the parameters and an uncertainty model 216, which can be a Gaussian and/or other distribution. For example, if the parameter type is a length of the tissue of interest, the uncertainty can be a probability distribution width, and the uncertainty model 216 can be a Gaussian distribution function.

For instance, FIG. 3 shows an example in which three different algorithms of the TOI algorithms 208 are used to identify three different boundaries 302, 304, and 306 of a tissue of interest. For example, the three different algorithms may be associated with three different image intensity thresholds. The uncertainty estimator 214 estimates a length 308 with an uncertainty 310, which is in terms of a width of a Gaussian probability distribution, in this example. The uncertainty estimation can be done, for example, by automatic algorithm which minimizes a cost function.

The uncertainty determiner 202 outputs an uncertainty for each of the parameter measurements. FIG. 4 shows a non-limiting example for visualizing the uncertainties. Images 402, 404 and 406 are acquired at three different moments in time. Each of the images 402, 404 and 406 includes three contours 408, 410 and 412, all for the same tissue of interest, but determined using different TOI algorithms of the TOI algorithms 208.

A graph 414 includes curves for the contours 408, 410 and 412. In the graph 414, a y-axis 416 represents tissue of interest volume and an x-axis 418 represents time. A first curve 420 represents a change in a volume of the tissue of interest over time based on a first algorithm, a second curve 422 represents a change in the volume of the tissue of interest over the same time based on a second algorithm, and a third curve 424 represents a change in the volume of the tissue of interest over the same time based on a third algorithm.

A fourth curve 425 represents the three curves 420, 422 and 424. It is to be appreciated that different techniques can be used to generate the fourth curve 425 and the resulting curve from each technique may differ from a curve from another technique. The graph 414 also includes uncertainties 426, 428, and 430 for each of the three different images 402, 404 and 406.

Returning to FIG. 2, an individual parameter response classes probability determiner 218 evaluates the uncertainties of the parameter measurements based on predetermined classification criteria 220. Such evaluation can be based on image modality, group of tissue of interest, and/or other grouping. The individual parameter response classes probability determiner 218 outputs a set of probabilities of response classes (e.g., CR, PR, SD and PD, according to pre-defined criteria such as RECIST) for each parameter measurement, or for each group of parameter measurement, according to the pre-defined criteria.

The following describes a non-limiting example of determining probabilities of response classes for each group of parameter measurement.

In this example, xᵢ represents parameter measurements of each combination of time, tissue of interest and parameter type where i is a running index, dxᵢ represents all corresponding estimated uncertainties, mdxᵢ represents all corresponding uncertainty model types, and v₁=v(t₁)=a set (i.e. the group) of all the xᵢ parameter values for all the i's parameters that are evaluated in time point t₁. v₀ is a set of reference or baseline parameters.

Furthermore, a function F(v) represents a function that acts on a set of specific values of parameters (e.g. sum of tissue of interest lengths, or a combination of lengths and mean image intensity). In one instance, all the same tissue of interest are evaluated in time points t₁ and t₀. In another instance, all the same tissue of interest are not evaluated in time points t₁ and t₀; some tissue of interest may not be evaluated in some time points.

A function G(F₁(v₁), F₀(v₀)) represents a response criterion function. The function G can be a linear or non-linear (or non-continuous) function, or a set of rules (e.g.

RECIST rules). In one instance, the function definition of F₁ is identical to that of F₀. In another instance, the function definition of F₁ is not identical to that of F₀. The response criterion defines a response class: s=G(F₁(v₁), F₀(v₀)) where s is a response class. Optionally, G can be a function of several time points, i.e. s=G(F₁(v₁), F₂(v₂), . . . F₀(v₀)) With the uncertainties determined by the uncertainty determiner 202, the individual parameter response classes probability determiner 218 determines a propagation scheme. Where F is a simple sum, e.g., =x₁+x₂+x₃+ . . . , then dX (in terms of normal probability distribution)=(dx₁²+dx₂²+dx₃²+ . . . )^{1/2} In such a case, dX₁, dX₀, . . . define the probability distributions of F₁(v₁), F₀(v₀) . . . , and uncertainty propagation can be applied for the function G to calculate the resultant probability distribution of the classes s.

If the uncertainty dX or all the dxᵢ represent standard deviation of normal distribution probability (or any other defined distribution), then the probabilities of s can be calculated by a Monte-Carlo simulation process, a direct numerical calculation (and where G can be any function), and/or other approach. For a general calculation description, rᵢ represents a specific selected possible value of Fᵢ, depending on the already estimated distribution of the function results. The probability of this value pⱼ(rᵢ) depends on the known distribution model of Fⱼ which defines the function of pⱼ.

If the probability of rᵢ is known (e.g. pⱼ(rᵢ)=n·exp((rᵢ²−Xⱼ²)/2/dXⱼ²) as in a Gaussian model, where n is used for normalization), the individual class probability determiner 210 can select a set (with index k) of: r₁, r₀, . . . corresponding to the evaluated parameters (e.g. in a random selection way or as an instance in a serial sequence) and calculate: Pₖ(s)=(p₁(r₁)·p₀(r₀)·. . . )·G(r₁,r₀, . . . )

This scheme is repeated for several or many different sets k of different r's while choosing the sets according to a proper scheme (effectively spanning uniformly all possible combinations). Since the uncertainties of F₁(v₁) and F₀(v₀) can be calculated once (i.e. dF₁ and dF₀) (especially if F is a linear function such as a sum), in that case r is a choice in the known distribution of F.

The scheme includes repeating the calculation of Pₖ(s) (the probability of each defined s) and summing, for each s, all the calculated probabilities (to obtain the final probability of each possible s). This is illustrated in FIG. 5, where F₁ is (for example) the probability distribution of possible total length sum of all tracked lesion in a current evaluation time point, and F₀ is (for example) the probability distribution of possible total length sum of all tracked lesion in the reference (baseline) evaluation time point.

In FIGS. 5, r₁ and r₀ are the selected values within these distributions in one iteration of the calculation. Applying the classification function G with the inputs r₁ and r₀ gives as the result the class s₂. The multiplication of the probabilities p₁ and p₀ give the probability of s₂ in this single iteration. This process is repeated with different values for r₁ and r₀, which can be randomly and/or otherwise selected. The classification probabilities are normalized at the end of the iterative process.

In a more general case, where F can be a more complex function, rᵢ represents a specific selected possible parameter value distributed around xᵢ, and that for all xᵢ in the group v, R₁ represents a set of r₁₁, r₁₂, r₁₃, . . . , R₀ represents a set of r₀₁, r₀₂, r₀₃, . . . , and p(rᵢ) depends on the reported uncertainty model type mdxᵢ which defines the function of p.

If the probability of rᵢ is known (e.g. p(rᵢ)=n·exp((rᵢ²−xᵢ²)/2/dxᵢ²) in a Gaussian model), a set (with index k) of: r₁, r₂, . . . corresponding to the evaluated parameters (e.g. in a random selection way or as an instance in a serial sequence) can be selected and Pₖ(s)=(p(r₁₁)·p(r₁₂)· . . . ·p(r₀₁)·p(r₀₂)· . . . )·G(F₁(R₁), F₀(R₀)) can be calculated.

This approach is repeated a plurality of times for different sets k of different r's while choosing the sets according to a predetermined scheme (e.g., to effectively span all possible combinations). r can be selected for all the parameters of the sets v₁ and v₀, . . .

Returning to FIG. 2, a combined response classes probability determiner 222 evaluates the individual probabilities of response classes for all modalities, imaging techniques, independent tissue of interest groups, response time points, etc. The following describes a non-limiting example of an evaluation performed by the combined response classes probability determiner 222.

With the possible response classes s₁, s₂, s₃, . . . (for example CR, PR, SD, PD), for a classification 1, the set of probabilities of response classes is [P₁(s₁), P₁(s₂), P₁(s₃), . . . ], for a classification 2, the set of probabilities of response classes: [P₂(s₁), P₂(x₂), P₂(s₃), . . . ], . . . sₐ represents a selected one of: s₁, s₂, s₃, . . . corresponding to sub-classification 1, s_{b} represents a selected one of: s₁, s₂, s₃, . . . corresponding to sub-classification 2, . . . , the combined response classes probability determiner 212 can employ a combination criteria standard such as: H=Response criterion (sₐ, s_{b}, . . . ), which can be a linear or a non-linear (or non-continuous) function, or a set of rules.

A response class determiner 224 determines a final estimated overall response classification. In one non-limiting instance, the response class determiner 224 determines a final estimated overall response classification by calculating, for a selected specific set of: sₐ, s_{b}, P(s)=(P₁(sₐ)·P₂(s_{b})· . . . )·H(sₐ, s_{b}). The response class determiner 224 repeats this for one or more different sets of (sₐ, s_{b}, . . . ). The sets are selected such that a sufficient number of sets is selected according to a predetermined scheme (e.g., effectively spanning all combinations).

The response class determiner 224 repeats the calculation of P(s) (the probability of each defined s and sums, for each s, all the calculated probabilities. As a final classification, the response class determiner 224, in one non-limiting instance, takes the s value with the highest total probability (e.g. the closest to the calculated ‘center of gravity’ (COG)). This is illustrated in connection with FIG. 6, which shows response class probability evaluation: P₁(s₁) is the probability of the class s₁ from the first modality, and P₂(s₃) is the probability of the class s₃ from the second modality.

Applying the classification function H with the inputs s₁ and s₃ gives as the result the class s₃. The multiplication of the probabilities P₁ and P₂ gives the probability of s₃ in this single iteration. The whole process is repeated for all the combinations of choices of s. The final classification probabilities can be normalized at the end of the iterative process. The final class is considered as the one who is closest to the center of gravity of the four probabilities.

The criteria H may be dependent also on external information regarding the patient condition, accuracy of imaging etc. For example, if for a certain disease it is known that PET is more accurate than CT, the PET classification may get higher weight.

In a variation of the above, uncertainties can be used also to select sufficiently appropriate target tissue of interest as the basis for the whole response monitoring evaluation, and to reject lesions with very high parameter uncertainties. The following describes three example evaluations, which are based on the example RECIST guideline of Table 1.

TABLE 1
Time point response: patients with
target (+/−non-target) disease.

| | | New | Overall |
|---|---|---|---|
| Target lesions | Non-target lesions | lesions | response |
| CR | CR | No | CR |
| CR | Non-CR/Non-PD | No | PR |
| CR | Not evaluated | No | PR |
| PR | Non-PD or | No | PR |
| | not all evaluated | | |
| SD | Non-PD or | No | SD |
| | not all evaluated | | |
| Not all | Non-PD | No | NE |
| evaluated | | | |
| PD | Any | Yes or No | PD |
| Any | PD | Yes or No | PD |
| Any | Any | Yes | PD |

CR = complete response,
PR = partial response,
SD = stable disease,
PD = progressive disease, and
NE = inevaluable.

For a first evaluation, no uncertainties are evaluated. Assuming the target lesions response is PR, and the non-target lesion response is Non-CR/Non-PD. Based on the rules, the overall response is PR. For a second evaluation, uncertainties are evaluated. In this example, the assumed obtained probability distributions are: The target lesion is 0.2*CR+0.5*PR+0.3*SD, and the non-target lesion is 0.7*NonCR/NonPD+0.3*PD. With this evaluation, the independent mean values of the two groups are still closer to PR and Non-CR/Non-PD which give together the original overall assessment above of PR.

For a third evaluation, the overall response of each combination is multiplied by the joint probabilities of the target and non-target lesion groups, as discussed herein, and the overall response is 0.14*PR+0.06*PD+0.35*PR+0.15*PD+0.21*SD+0.09*PD, which equals 0.49*PR+0.21*SD+0.3*PD. The center of gravity (COG) of the distributions is (with defining: CR-1, PR-2, SD-3, PD-4): COG=(0.49*2+0.21*3+0.3*4)/(0.49+0.21+0.3), or 2.81, which rounds to SD (round(2.81)=3), so the overall response is SD.

For this example, the final response class of SD is a more accurate reflection of the actual response of the tissue of interest to the therapy treatment than the other two evaluations, which resulted response classes of PR.

FIG. 7 illustrates an example method in accordance with the embodiments described herein.

It is to be appreciated that the ordering of the acts in the methods described herein is not limiting. As such, other orderings are contemplated herein. In addition, one or more acts may be omitted and/or one or more additional acts may be included.

At 702, imaging data is obtained.

At 704, parameter measurements are determined for tissue of interest from the imaging data.

At 706, an uncertainty is estimated for each of the parameter measurements.

At 708, response classification criteria is obtained.

At 710, probabilities of response classes are determined for each parameter measurement or group of parameters, based on the parameter values, their uncertainties and the response classification criteria.

At 712, the probabilities of response classes are combined based on predetermined combining criteria.

At 714, a final response class is determined for the tissue of interest based on the combined probabilities of response classes.

The above may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for determining a final response class of tissue of interest to a therapy treatment, comprising:
obtaining a first set of probabilities of response classes;
obtaining at least a second set of probabilities of the response classes;
combining the first and the at least second sets of probabilities of the response classes, thereby generating a combined set of probabilities of the response classes,
determining the final response class of the tissue of interest to the therapy treatment from a plurality of predefined response classes based on the combined set of probabilities of the response classes; and
generating a signal indicative of the final response class.

2. The method of claim 1, wherein the response classes include at least a first class indicative of a first response of the tissue of interest to the therapy treatment and a second class indicative of a second response of the tissue of interest to the therapy treatment, wherein the first and the second responses are different.

3. The method claim 1, wherein at least one of the first or the at least the second set of probabilities is generated based on imaging data acquired from a same imaging modality.

4. The method of claim 1, wherein at least one of the first or the at least the second set of probabilities is based on a group of the tissue of interest.

5. The method of claim 2, further comprising:
determining a parameter measurement based on the imaging data;
determining an uncertainty of the parameter measurement; and
determining at least one of the first or the at least the second set of probabilities based on the uncertainty and predetermined response criteria.

6. The method of claim 4, wherein at least one of the first or the at least the second set of probabilities is based on a second group of tissue that does not include the tissue of interest.

7. The method of claim 1, wherein at least one of the first or the at least the second set of probabilities is based on a response time point.

8. The method of claim 1, wherein determining the final response class includes selecting a response class of the plurality of the response classes with a highest total probability.

9. The method of claim 1, wherein the predetermined response classification criteria includes response classes from a group consisting of complete response; partial response, stable disease; and progressive disease.

10. The method of claim 1, wherein determining the final response class comprises:
randomly selecting a response class of the first set of probabilities;
randomly selecting a response class of the second set of probabilities;
combining the probabilities corresponding to the selected response class of the first set of probabilities and the probabilities corresponding to the selected response class of the second set of probabilities based on predetermined combining criteria; and
repeating, one or more times, the acts of randomly selecting response classes of the first and the second set of probabilities and combining the probabilities.

11. The method of claim 10, wherein combining the probabilities includes multiplying the probabilities.

12. The method of claim 10, further comprising:
determining the final response class based on a center of gravity of the probabilities, wherein the final response class is closest to a center of gravity of the probabilities.

13. A therapy response classifier, comprising:
a combined response classes probability determiner that is configured to combine a first set and at least a second set of probabilities of response classes for tissue of interest to a therapy treatment, generating a combined set of probabilities of the response classes, and
a response class determiner that is configured to determine a final response class of the tissue of interest to the therapy treatment from the response classes based on the combined set of probabilities of the response classes.

14. The therapy response classifier of claim 13, wherein the response classes include at least a first class indicative of a first response of the tissue of interest to the therapy treatment and a second different class indicative of a second response of the tissue of interest to the therapy treatment.

15. The therapy response classifier of claim 13, wherein at least one of the first or the at least the second set of probabilities is generated based on one or more of imaging data acquired from a same imaging modality, a group of the tissue of interest, a group of tissue other than the tissue of interest, or a response time point.

16. The therapy response classifier of claim 13, further comprising:
a measurement determiner that is configured to determine a parameter measurement based on the imaging data;
an uncertainty estimator that is configured to determine an uncertainty of the parameter measurement; and
an individual parameter response classes probability determiner that is configured to determine probabilities of response classes for each parameter measurement or group of parameters based on parameter values, parameter value uncertainties, and response classification criteria.

17. The therapy response classifier of claim 16, wherein the predetermined response criteria includes at least one of Response Evaluation Criteria in Solid Tumors criteria or PET Response Criteria In Solid Tumors criteria.

18. The therapy response classifier of claim 13, wherein the response class determiner is configured to determine a final response class as the response class with a highest total probability.

19. The therapy response classifier of claim 13, wherein the combined response classes probability determiner combines a randomly selected a response class of the first set of probabilities and a randomly selected response class of the second set of probabilities based on predetermined combining criteria for multiple iterations, and the response class determiner determines the final response class based on a center of gravity of the probabilities.

20. A computer readable storage medium encoded with computer readable instructions, which, when executed by a processer, causes the processor to:
obtain at least two sets of probabilities of response classes, wherein the response classes include at least two classes indicative of two different response of tissue of interest to a therapy treatment;
combine the at least two sets of probabilities; and
determine a final response class of the tissue of interest to the therapy treatment based on the combined at least two sets of probabilities.
